(19) United States
(12) Patent Application Publication
(10) Pub. No.: US 2025/0228409 A1
(43) Pub. Date: Jul. 17, 2025

(54) Condiment Container Spinning Device for Removing Viscous Condiment

(71) Applicant: Pete Miller, Baldwin, WI (US)

(72) Inventor: Pete Miller, Baldwin, WI (US)

(21) Appl. No.: 18/731,434

(22) Filed: Jun. 3, 2024

Related U.S. Application Data
(60) Provisional application No. 63/620,997, filed on Jan. 15, 2024.

(51) Int. Cl. A47J 43/27

(52) U.S. Cl. CPC A47J 43/27

(57) ABSTRACT

A condiment container spinning device for rotating a condiment container to extract viscous product/contents from the container through centrifugal force generated by rotating the container is disclosed. The device has a container accommodating the caddie device and a handle adapted to removably attach to the caddie device for rotating the caddie device and the accommodated container. The caddie device has a base and a frame along with a strap. The condiment container is placed in an inverted position with the cap end thereof positioned on the base and the container is secured using the strap. The handle has a ball bearing hook which is removably attached to the frame and the container is rotated by slowly rotating the handle. Centrifugal force is applied to the condiment inside the container due to the rotation to push the condiment toward the cap end of the container.

### CROSS-REFERENCE TO RELATED APPLICATION

The present application claims priority to, and the benefit of, U.S. Provisional Application No. 63/620,997, which was filed on Jan. 15, 2024, and is incorporated herein by reference in its entirety.

### FIELD OF THE INVENTION

The present invention generally relates to the field of kitchen accessory devices. More specifically, the present invention relates to a novel spinning device for condiment bottles that enables users to extract all the contents that may be stuck to the bottom or sides of the condiment container/bottle. The device includes an ergonomic handle with a ball-bearing hook. The bearing is fastened to the handle, and the device features a bottle caddie that the bottle will slide into in an inverted position. The handle is removably attached to the caddie and the caddie along with the accommodated bottle is rotated on slow rotation of the handle in a hand by a user. During rotation, optimal centrifugal force is generated that enables the viscous product/contents to be moved up toward the cap end of the bottle for easy removal. Accordingly, the present disclosure makes specific reference thereto. Nonetheless, it is to be appreciated that aspects of the present invention are also equally applicable to other like applications, devices, and methods of manufacture.

### BACKGROUND

By way of background, people commonly use high-viscosity condiments/contents like honey or ketchup in kitchens and shampoos, conditioners, or hand lotions in bathrooms. Such condiments/contents generally come in bottles or containers and high viscosity makes the condiments/contents resistant to flow. Viscosity refers to the thickness of a liquid and its resistance to flow. Due to their thickness and viscosity, getting these condiments/contents out of their containers, especially when the content is low, can be challenging.

People often turn the bottle upside down but this method is not effective, especially when the quantity of the condiment is low. The high viscosity of the condiment prevents it from flowing freely. Many individuals use tools like spoons or spatulas to scrape the condiment out of the container. However, this process can be time-consuming and inconvenient. A common technique used is to tap or hit the bottom of the bottle to encourage the product to move toward the opening. However, this method does not work especially if the bottle has a narrow neck or if the product is too thick. Alternatively, individuals may hold the container in their hand with the cap pointing down and then swing their arm and the container around the shoulder. This method risks the bottle or container slipping from the hand and shattering on the floor or wall. When the container is made of glass, hitting the container too hard could lead to breakage, posing a risk of injury. Given the above challenges, there is a desire for more efficient methods to extract all the viscous condiment products from the bottles enabling people to get full value from the purchased product.

Therefore, there exists a long-felt need in the art for an improved way to enable people to easily extract all remaining viscous condiments/contents from corresponding bottles or containers. There is also a long-felt need in the art for a device that can be used with condiment containers for easily removing viscous condiments/contents from containers. Additionally, there is a long-felt need in the art for a novel device that can spin a condiment container for retrieving viscous condiments/contents. Moreover, there is a long-felt need in the art for a spinning device for condiments/contents and other viscous product/contents bottles that enable people to easily extract all remaining contents from the bottle. Further, there is a long-felt need in the art of a spinning device that rotates a condiment bottle safely to force the condiment to the cap end of the bottle. Furthermore, there is a long-felt need in the art for a device to remove condiments/contents from a bottle without requiring tapping, shaking, and using tools, such as a spatula. Finally, there is a long-felt need in the art for a novel device that offers a much easier and more effective method of removing viscous condiment from a bottle using rotational motion and centrifugal force.

The subject matter disclosed and claimed herein, in one embodiment thereof, comprises a condiment container spinner device for extracting viscous product/contents from a bottle. The device includes a bottle caddie device designed to accommodate various sizes and shapes of condiment bottles, the caddie has a selectable insert to accommodate a wide variety of types and sizes of bottle/jar lids and caps, a frame connected to the base comprising vertical elements and diagonal arms forming an irregular pentagon, a support plate across the vertical arms for additional bottle support, a selectable and customizable insert, and a strap for securing the bottle to the support plate. The bottle is secured using the strap. A handle including a ball bearing hook is removably attached to the frame of the caddie device and facilitates spinning of the bottle caddie device wherein rotation of the handle applies centrifugal force to the bottle to move the viscous product/contents towards the bottle cap aiding in the extraction of the viscous product/contents.

In this manner, the condiment container spinner device of the present invention accomplishes all of the foregoing objectives and provides users a spinning device for condiments/contents and other viscous product/contents bottles that enable people to easily extract all remaining contents to get full value from the purchased product. The device enables the product container to be secured into the device and then rotated to utilize gravity and centrifugal force to move the condiment product toward the cap of the bottle for easy dispensing. The device eliminates shaking and tapping the bottle and prevents use of tools such as a spatula for taking out the viscous condiments/contents. The device offers a much easier and more effective method of ensuring all products from a condiment bottle is retrieved and used before throwing away the bottle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a condiment spinner device designed to efficiently extract viscous condiments/contents such as ketchup and honey from bottles or containers. The device utilizes centrifugal force to move the remainder of the viscous product/contents off the sides and base of the bottle, thereby reducing the need to shake or hit the bottom of the bottle. The device includes a bottle caddie for accommodating a condiment bottle, the caddie accepts inserts (i.e., standard and customizable) that can be held in place with magnets proximal to the base, the frame is shaped as an irregular pentagon, made of vertical, diagonal, and horizontal arms. The device also has a handle which includes a ball bearing hook at one end thereof to attach to the caddie device, enabling smooth 360-degree rotation of the caddie device to rotate the accommodated condiment bottle.

In another aspect, a condiment spinner device for accommodating and spinning a condiment container is disclosed. The condiment spinner device features a caddie device having a frame that extends transversely upwards from a base, the frame has a set of vertical elements which extend upward from a base and a set of diagonal arms, each diagonal arm extends from the top end of the corresponding vertical element at an angle diverging away from the longitudinal axis of the vertical element, a horizontal arm connects the top ends of the diagonal arms. A support plate extends between the vertical elements and has a strap looped across a pair of opposite holes disposed in the support base for supporting a condiment bottle. A handle has a ball bearing hook which is adapted to removably attach to the horizontal arm of the caddie device, wherein the handle is rotated circularly using a ball bearing to rotate the hook and the attached caddie device 360-degrees, to apply a centrifugal force to the viscous condiment stored inside the accommodated condiment bottle.

In yet another embodiment, a condiment container spinning device is disclosed. The device includes a caddie device for securing and accommodating a condiment container and a handle, the handle is adapted to removably attach to the caddie device using an integrated ball bearing hook. The caddie device has a base and a frame, the frame extends transversely upward from the base and includes a support plate having a looped strap. The condiment container is accommodated with the cap end of the container placed on the upper surface of the base and the container secured using the strap. The ball bearing hook of the handle is adapted to removably attach to the frame enabling a user to rotate the handle, thereby rotating the caddie device and the accommodated container. During rotation, the container is held generally perpendicular to the center axis of rotation and parallel to the center plane of rotation, thereby a centrifugal force is applied to move the condiment to the cap end of the container.

In a further embodiment, a condiment spinner device for extracting viscous product/contents from a bottle is disclosed. The device includes a bottle caddie device designed to accommodate various sizes and shapes of condiment bottles, the caddie has a selectable insert to accommodate a wide variety of types and sizes of bottle lids/caps, a frame connected to the base, comprising vertical elements and diagonal arms forming an irregular pentagon, a support plate across the vertical arms for additional bottle support, and a strap for securing the bottle to the support plate. A handle with a ball bearing hook facilitates spinning of the bottle caddie device wherein rotation of the handle applies centrifugal force to the bottle, aiding in the extraction of the viscous product/contents.

In yet another aspect of the present invention, a method for extracting viscous product/contents from a bottle using a condiment spinner device is described. The method includes the steps of placing a condiment bottle in an inverted position with the cap end directed at a bottom in a bottle caddie device, the caddie includes a base and a frame, the frame has a support plate and a strap, securing the bottle with a strap to a support plate, attaching the caddie device to an ergonomic handle via a ball bearing hook, rotating the handle in a circular motion, generating centrifugal force within the bottle to move the viscous product/contents towards the bottle cap, and extracting the viscous product/contents efficiently without the need to shake or hit the bottle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the condiment container spinning device of the present invention in an unassembled form in accordance with the disclosed architecture;

FIG. 2 illustrates a perspective view of the condiment spinner device of the present invention in an assembled form in accordance with the disclosed structure;

FIG. 3 illustrates a perspective view of the condiment bottle being accommodated in the caddie device for rotation to remove the remaining product from the bottle in accordance with the disclosed structure; and

FIG. 4 illustrates a perspective view showing rotation of the condiment container using the condiment container spinning device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved way to enable people to easily extract all remaining viscous condiments/contents from corresponding bottles or containers. There is also a long-felt need in the art for a device that can be used with condiment containers for easily removing viscous condiments/contents from containers. Additionally, there is a long-felt need in the art for a novel device that can spin a condiment container for retrieving viscous condiments/contents. Moreover, there is a long-felt need in the art for a spinning device for condiments/contents and other viscous product/contents bottles that enable people to casily extract all remaining contents from the bottle. Further, there is a long-felt need in the art of a spinning device that rotates a condiment bottle safely to force the condiment to the cap end of the bottle. Furthermore, there is a long-felt need in the art for a device to remove condiments/contents from a bottle without requiring tapping, shaking, and using tools, such as a spatula. Finally, there is a long-felt need in the art for a novel device that offers a much easier and more effective method of removing viscous condiment from a bottle using rotational motion and centrifugal force.

The present invention, in one exemplary embodiment, is a condiment spinner device for accommodating and spinning a condiment container. The condiment spinner device features a caddie device having a frame that extends transversely upwards from a base, the frame has a set of vertical elements which extend upward from a base and a set of diagonal arms, each diagonal arm extends from the top end of the corresponding vertical element at an angle diverging away from the longitudinal axis of the vertical element, a horizontal arm connects the top ends of the diagonal arms. A support plate extends between the vertical elements and has a strap looped across a pair of opposite holes disposed in the support base for supporting a condiment bottle. A handle has a ball bearing hook which is adapted to removably attach to the horizontal arm of the caddie device, wherein the handle is rotated circularly using a ball bearing to rotate the hook and the attached caddie device 360-degrees, to apply a centrifugal force to the viscous condiment stored inside the accommodated condiment bottle.

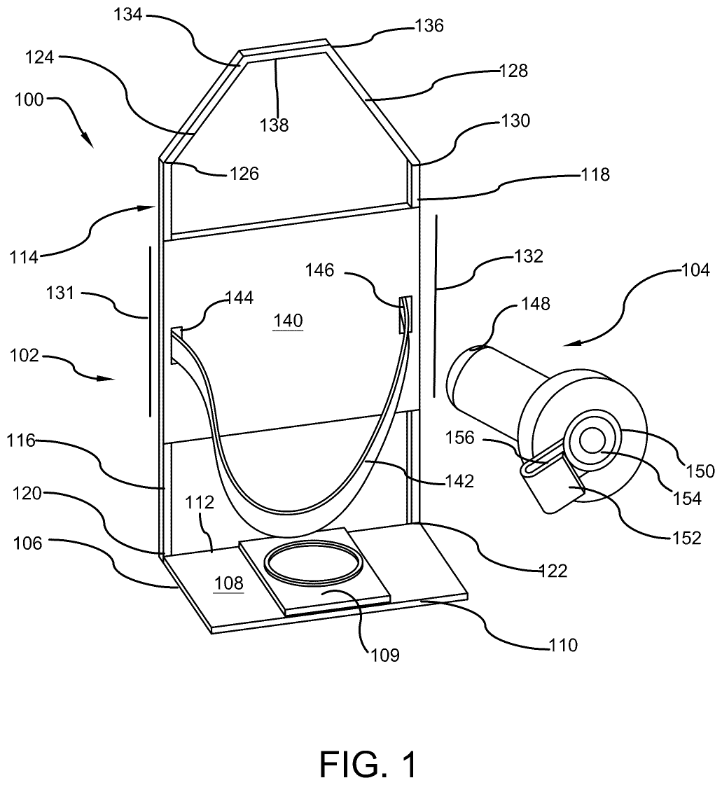

Referring initially to the drawings, FIG. 1 illustrates a perspective view of the condiment container spinning device of the present invention in an unassembled form in accordance with the disclosed architecture. The condiment spinner device 100 of the present invention is designed to efficiently extract condiments/contents such as viscous ketchup, honey, and more from bottles or containers. More specifically, the condiment spinner device 100 enables people to easily extract condiments/contents and other viscous product/contents from bottles without having to hit the bottom of a bottle or shake it to try. The device 100 forces the remainder of a viscous product/contents off the sides and base of the bottle/container.

The condiment spinner device 100 includes a bottle caddie device 102 and a handle 104. The bottle caddie device 102 is dimensioned to accommodate a variety of conventional condiment bottles and can be designed in different sizes and shapes. The bottle caddie device 102 has a generally rectangular base 106 having an upper surface 108 for supporting an insert 109 and a container bottle. It is to be appreciated that the insert 109 can be selected based upon the type and size of the container bottle cap/lid. The insert 109 can be magnetically adhered or secured to the upper surface 108 of the base 106. The base 106 has a trailing edge 110 and an opposite supporting edge 112. A frame 114 having a pair of vertical elements/arms 116, 118 extends transversely upward from the opposite ends 120, 122 of the supporting edge 112 of the base 106.

A first diagonal arm 124 is disposed at the top end 126 of the first vertical element 116 and a second diagonal arm 128 is disposed at the top end 130 of the second vertical element 118. Each diagonal arm 124, 128 is disposed at an angle that departs away from the longitudinal axis 131, 132 of the vertical elements 116, 118. The top end 134 of the first diagonal arm 124 and the top end 136 of the second diagonal arm 128 are connected using a horizontal arm 138. The horizontal arm 138, the diagonal arms 124, 128, and the vertical elements 116, 118 form the frame 114 which is shaped as an irregular pentagon.

A support plate 140 is disposed across the vertical arms 116, 118 for providing support to a condiment bottle accommodated in the bottle caddie device 102. The support plate 140 can be welded or fastened using any mechanical fasteners. A strap 142 is looped across the two opposite openings 144, 146 disposed in the support plate 140 and is used for strapping a condiment bottle in the caddie device 102. The strap 142 helps in adhering the bottle to the support plate 140.

The handle 104 of the device 100 is ergonomic and is used for spinning a condiment bottle accommodated in the bottle caddie device 102. The handle 104 has a first end 148 and an opposite second end 150. The second end 150 includes a ball bearing hook 152 adapted to hook or fasten the bottle caddie device 102. Specifically, the ball bearing hook 152 is hooked to the horizontal arm 138 of the frame 114. The ball bearing 154 facilitates rotation of the hook 152 and the attached caddie device 102 when the handle 104 is rotated in circular motion by a user. When the handle 104 is rotated in a circular motion, a centrifugal force is applied to cause movement of the hook 152 and the attached caddie device 102 with the accommodated condiment bottle.

The hook 152 is grooved to securely fit the horizontal arm 138 without any slipping or sliding of the horizontal arm 138 within the groove 156. The frame 114 remains secured and does not detach from the handle 104 without any intentional disengagement by the user.

The bottle caddie device 102 can be made from plastic, metal, wood, or any other durable and corrosion-resistant material. The handle 104 can also be made of the same or any different material. Further, rotation of a condiment bottle is easy using the handle 104 and the caddie device 102, thereby ensuring all product from the bottle is extracted before throwing the condiment bottle away. Both the caddie device 102 and the handle 104 can come in different sizes and colors.

In some embodiments, the vertical arms 116, 118 are telescoping enabling the arms 116, 118 to extend and retract, thereby enabling the base 106 to move upwards and downwards for supporting condiment bottles of different sizes.

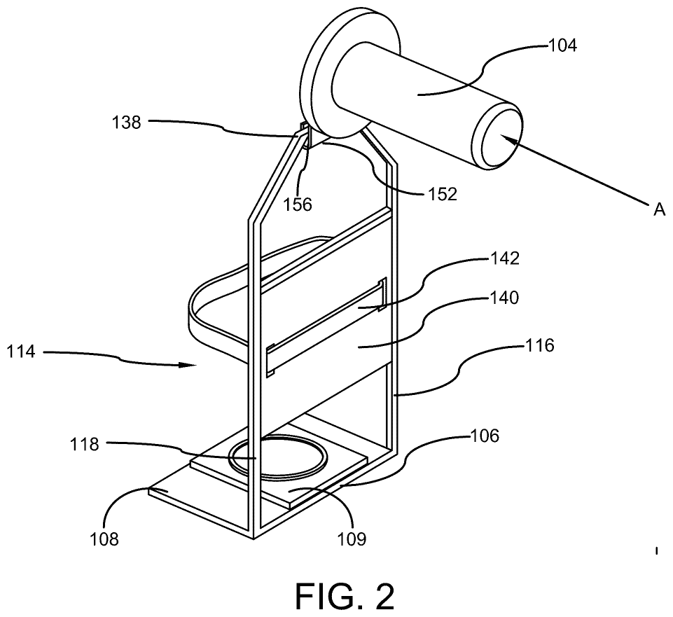

FIG. 2 illustrates a perspective view of the condiment spinner device of the present invention in an assembled form in accordance with the disclosed structure. In the assembled form, the bearing hook 152 is fastened to the frame 114, specifically to the horizontal arm 138. In the assembled form, the caddie device 102 and the accommodated condiment bottle are held perpendicular to the central axis of rotation (Arrow A). It will be appreciated that the handle 104 can be gripped easily while the caddie device 102 is fastened to the handle 104.

The handle 104 can be moved in a small circular motion to rotate the ball bearing hook 152 and the attached caddie device 102. During rotation of the caddie device 102 and the accommodated condiment bottle, optimal centrifugal force is generated that enables the viscous product/contents inside the condiment container to move up towards the cap for easy removal.

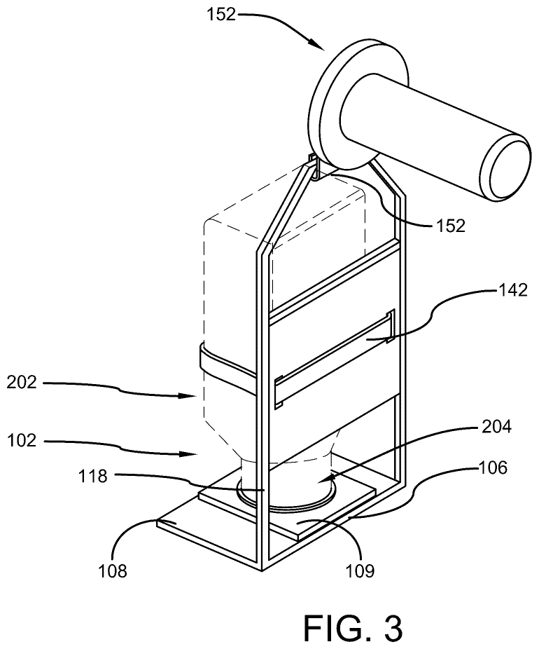

FIG. 3 illustrates a view of the condiment bottle being accommodated in the caddie device for rotation to remove the remaining product from the bottle in accordance with the disclosed structure. The condiment bottle 202 is slid into the caddie device 102 in an inverted orientation with the cap 204 at the bottom such that the cap 204 rests on the insert 109 which is adhered to the upper surface 108 of the generally rectangular base 106. The condiment bottle 202 is secured using the strap 142 for preventing falling away of the bottle 202 from the caddie device 102 during rotation.

It will be apparent to a person skilled in the art that the caddie device 102 is designed to enable the condiment container 102 to be kept in an inverted position, thereby enabling the use of gravity along with centrifugal force to force the viscous product/contents (inside the bottle 202) toward the cap 204 for easy dispensing.

The ball bearing 154 facilitates 360-degrees rotation of the caddie device 102 when the handle 102 and the caddie device 102 are fastened. This eliminates hitting the bottom of a bottle or shaking the bottle to try and force the remainder of a viscous product/contents off the sides and base of the bottle. The handle 104 is ergonomic and reduces strain on the wrist of a user operating the device 100.

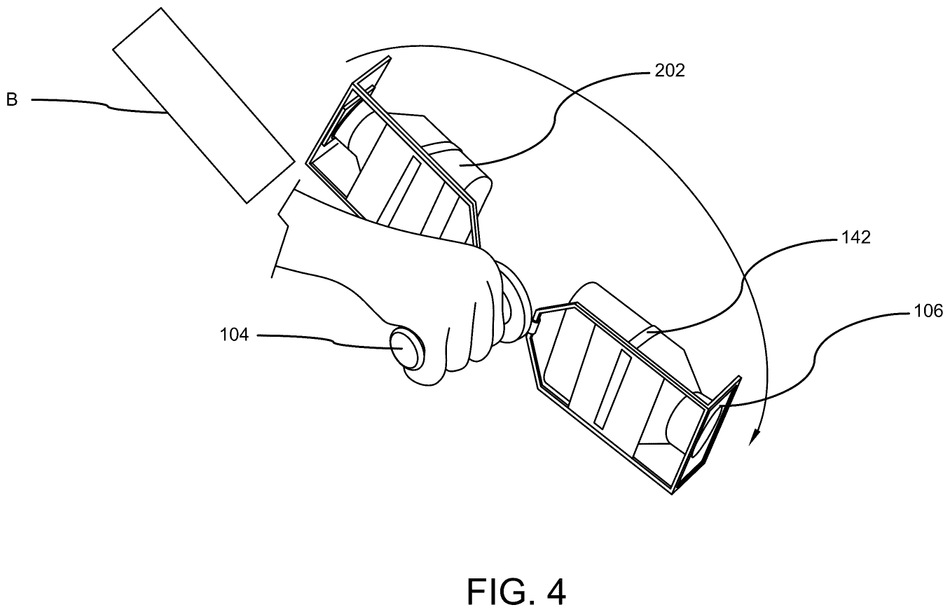

FIG. 4 illustrates a perspective view showing rotation of the condiment container using the condiment container spinning device of the present invention in accordance with the disclosed structure. For rotating the condiment container 202 and generating centrifugal force to force the viscous content of the bottle 202, the handle 104 is gripped and rotated in a small circular motion for rotation of the caddie device 102. The caddie device 102 rotates 360-degrees and the content of the bottle 202 is gathered at the cap end 204 of the bottle 202, ensuring minimal waste.

During use, the bottle 202 is held perpendicular to the center axis of rotation and parallel to the center plane of rotation. The specific orientation ensures that the centrifugal force acts effectively on the condiment inside the bottle. The bottle 202 is held perpendicular to the center axis of rotation (Arrow A, FIG. 2) and parallel to the center plane of rotation (Arrow B, FIG. 4).

In one embodiment, a method for extracting viscous product/contents from a bottle using a condiment spinner device is described. The method includes the steps of placing a condiment bottle in an inverted position with the cap end at the bottom in a bottle caddie device, the caddie includes a base and a frame, the frame has a support plate and a strap, securing the bottle with a strap to a support plate, attaching the caddie device to an ergonomic handle via a ball bearing hook, rotating the handle in a circular motion, generating centrifugal force within the bottle to move the viscous product/contents towards the bottle cap, and extracting the viscous product/contents efficiently without the need to shake or hit the bottle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “condiment container spinning device”, “condiment spinner device”, “viscous condiment removal device”, and “device” are interchangeable and refer to the condiment container spinning device 100 of the present invention.

Notwithstanding the foregoing, the condiment container spinning device 100 of the present invention can be of any suitable size and configuration as is known in the art without affecting the overall concept of the invention, provided that it accomplishes the above-stated objectives. One of ordinary skill in the art will appreciate that the condiment container spinning device 100 as shown in the FIGS. are for illustrative purposes only, and that many other sizes and shapes of the condiment container spinning device 100 are well within the scope of the present disclosure. Although the dimensions of the condiment container spinning device 100 are important design parameters for user convenience, the condiment container spinning device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A spinner device for extracting viscous contents, the spinner device comprising:
a bottle caddie having a frame and a handle;
wherein said frame having a base and an upper surface for supporting a condiment bottle;
wherein said base having a trailing edge and an opposing supporting edge;
wherein said frame having a first vertical arm and a second vertical arm extending transversely upward from opposing ends of said supporting edge of said base;
wherein a first diagonal arm is connected at a top end of said first vertical arm and a second diagonal arm is connected at a top end of said second vertical arm;
wherein said first diagonal arm and said second diagonal arm extend at an angle inward from said top ends;
wherein a top end of said first diagonal arm and a top end of said second diagonal arm are connected by a horizontal arm; and
further wherein said first vertical arm and said second vertical arm having a support plate disposed thereacross for providing support to the condiment bottle accommodated in said bottle caddie.

2. The spinner device for extracting viscous contents of claim 1, wherein said support plate having a strap looped across opposing sides of said support plate for strapping the condiment bottle to said frame.

3. The spinner device for extracting viscous contents of claim 1, wherein said handle connected to a center of said horizontal arm, wherein said handle having a first end and a second end, and further wherein said second end having a ball bearing hook for rotating said frame around said ball bearing hook.

4. The spinner device for extracting viscous contents of claim 1, wherein said first vertical arm and said second vertical arm are telescoping arms.

5. The spinner device for extracting viscous contents of claim 4, wherein the condiment bottle held in said frame perpendicular to an axis of rotation.

6. The spinner device for extracting viscous contents of claim 1, wherein said bottle caddie is dimensioned to accommodate a variety of sizes of condiment bottles.

7. The spinner device for extracting viscous contents of claim 6, wherein said base is rectangular.

8. A spinner device for extracting viscous contents, the spinner device comprising:
a bottle caddie having a frame and a handle;
wherein said frame having a base and an upper surface for supporting a condiment bottle;
wherein said base having a trailing edge and an opposing supporting edge;
wherein said frame having a first vertical arm and a second vertical arm extending transversely upward from opposing ends of said supporting edge of said base;
wherein a first diagonal arm is connected at a top end of said first vertical arm and a second diagonal arm is connected at a top end of said second vertical arm;
wherein said first diagonal arm and said second diagonal arm extend at an angle inward from said top ends;
wherein a top end of said first diagonal arm and a top end of said second diagonal arm are connected by a horizontal arm;
wherein said handle connected to a center of said horizontal arm;
wherein said handle having a first end and a second end; and
further wherein said second end having a ball bearing hook for rotating said frame around said ball bearing hook.

9. The spinner device for extracting viscous contents of claim 8, wherein said first vertical arm and said second vertical arm having a support plate disposed thereacross for providing support to the condiment bottle accommodated in said bottle caddie.

10. The spinner device for extracting viscous contents of claim 9, wherein said support plate having a strap looped across opposing sides of said support plate for strapping the condiment bottle to said frame.

11. The spinner device for extracting viscous contents of claim 8, wherein said first vertical arm and said second vertical arm are telescoping arms.

12. The spinner device for extracting viscous contents of claim 8, wherein the condiment bottle held in said frame perpendicular to an axis of rotation.

13. A method for extracting viscous contents from a bottle, the method comprising the steps of:
providing a bottle caddie having a frame and a handle, wherein said frame having a base and an upper surface for supporting an insert and a condiment bottle, wherein said base having a trailing edge and an opposing supporting edge, further wherein said frame having a first vertical arm and a second vertical arm extending transversely upward from opposing ends of said supporting edge of said base;
connecting a first diagonal arm at a top end of said first vertical arm and connecting a second diagonal arm at a top end of said second vertical arm, wherein said first diagonal arm and said second diagonal arm extend at an angle inward from said top ends;
connecting a top end of said first diagonal arm and a top end of said second diagonal arm with a horizontal arm;
connecting said handle to a center of said horizontal arm, wherein said handle having a first end and a second end, further wherein said second end having a ball bearing hook; and
rotating said frame around said ball bearing hook.

14. The method for extracting viscous contents from a bottle of claim 13 further comprising a steps of placing the condiment bottle cap into said insert and placing the condiment bottle into said bottle caddie in an inverted orientation with the condiment bottle cap of the condiment bottle resting on said insert.

15. The method for extracting viscous contents from a bottle of claim 14 further comprising a step of strapping the condiment bottle to said frame of said bottle caddie with a strap.

16. The method for extracting viscous contents from a bottle of claim 15, wherein said rotating said frame around said ball bearing hook includes multiple 360-degree rotations.

17. The method for extracting viscous contents from a bottle of claim 16, wherein said first vertical arm and said second vertical arm having a support plate disposed thereacross for providing support to the condiment bottle accommodated in said bottle caddie.

18. The method for extracting viscous contents from a bottle of claim 17, wherein said support plate having said strap looped across opposing sides of said support plate for strapping the condiment bottle to said frame.

19. The method for extracting viscous contents from a bottle of claim 18, wherein said first vertical arm and said second vertical arm are telescoping arms.

20. The method for extracting viscous contents from a bottle of claim 16, wherein the condiment bottle during said rotating said frame around said ball bearing hook is perpendicular to a center axis of rotation and parallel to a center plane of rotation.
